(19) United States
(12) Patent Application Publication
(10) Pub. No.: US 2019/0311042 A1
(43) Pub. Date: Oct. 10, 2019

(54) INTELLIGENT INCENTIVE DISTRIBUTION

(71) Applicant: DiDi Research America, LLC, Mountain View, CA (US)

(72) Inventors: Qingyang LI, Sunnyvale, CA (US); Zhiwei QIN, San Jose, CA (US)

(21) Appl. No.: 15/944,905

(22) Filed: Apr. 4, 2018

(51) Int. Cl. G06F 17/30; G06K 9/62; G06F 15/18

(52) U.S. Cl. CPC G06F 17/3053; G06K 9/6256; G06F 15/18; G06F 17/30604; G06F 17/30551

(57) ABSTRACT

Incentive distribution may be determined by obtaining feature information for entities. The feature information may characterize features of individual entities. Predicted returns from providing individual incentives associated with different costs to the individual entities may be determined based on the feature information. Return metric from providing the individual incentives to the individual entities may be determined based on the predicted returns and the costs of the individual incentives. A set of incentives to be provided to one or more of the entities may be identified based on the return metric.

### NOTICE

© Copyright, DiDi Research America, LLC 2018. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The disclosure relates generally to determining distribution of incentives.

### BACKGROUND

Persons may be motivated to take particular actions based on incentives. Computing technology for determining incentive distribution based on static factors may result in poor allocation of incentives. An intelligent and adaptive tool to technically improve determination of incentive distribution is desirable.

### SUMMARY

One aspect of the present disclosure is directed to a method for determining incentive distribution. The method may comprise: obtaining feature information for entities, the feature information characterizing features of individual entities; determining predicted returns from providing individual incentives associated with different costs to the individual entities based on the feature information; determining return metric from providing the individual incentives to the individual entities based on the predicted returns and the costs of the individual incentives; and identifying a set of incentives to be provided to one or more of the entities based on the return metric.

Another aspect of the present disclosure is directed to a system for determining incentive distribution. The system may comprise one or more processors and a memory storing instructions. The instructions, when executed by the one or more processors, may cause the system to perform: obtaining feature information for entities, the feature information characterizing features of individual entities; determining predicted returns from providing individual incentives associated with different costs to the individual entities based on the feature information; determining return metric from providing the individual incentives to the individual entities based on the predicted returns and the costs of the individual incentives; and identifying a set of incentives to be provided to one or more of the entities based on the return metric.

In some embodiments, the entities may include at least one passenger of a vehicle. In some embodiments, the entities may include at least one driver of a vehicle.

In some embodiments, the set of incentives may be identified further based on a budget for a period of time. For instance, identifying the set of incentives may include: identifying incentives with highest return metric for the individual entities; and selecting the incentives with the highest return metric in an order of highest to lowest return metric until a sum of the costs of the selected incentives reaches the budget.

In some embodiments, the predicted returns may be determined based on a deep-Q network. The deep-Q network may be trained using historical information for the entities, where the historical information characterizes activities of the entities for a period of time. For instance, the deep-Q network may be trained using the historical information for the entities based on: storage of at least a portion of the historical information in a replay memory; sampling of a first dataset of the information stored in the replay memory; and training of the deep-Q network using the first sampled dataset.

In some embodiments, the deep-Q network may be updated using transition information for the entities, where the transition information characterizes activities of the entities after the set of incentives have been provided to the one or more of the entities. For instance, the deep-Q network may be updated using the transition information for the entities based on: storage of at least a portion of the transition information in the replay memory, the storage of the at least the portion of the transition information in the replay memory causing at least some of the historical information stored in the replay memory to be removed from the replay memory; sampling of a second dataset of the information stored in the replay memory; and updating of the deep-Q network using the second sampled dataset.

In some embodiments, updating of the deep-Q network may include a change in a last layer of the deep-Q network. The last layer may represent available incentive actions.

In another aspect of the disclosure, a system for determining incentive distribution may comprise one or more processors and a memory storing instructions. The instructions, when executed by the one or more processors, may cause the system to perform: obtaining feature information for entities, the feature information characterizing features of individual entities; determining predicted returns from providing individual incentives associated with different costs to the individual entities based on the feature information and a deep-Q network; determining return metric from providing the individual incentives to the individual entities based on the predicted returns and the costs of the individual incentives; and identifying a set of incentives to be provided to one or more of the entities based on the return metric and a budget for a period of time, wherein identifying the set of incentives includes: identifying incentives with highest return metric for the individual entities; and selecting the incentives with the highest return metric in an order of highest to lowest return metric until a sum of the costs of the selected incentives reaches the budget.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment for determining incentive distribution, in accordance with various embodiments of the disclosure.

FIGS. 2A-2B illustrate example data for training a deep-Q network, in accordance with various embodiments of the disclosure.

FIG. 3A illustrates example inputs and outputs of a deep-Q network, in accordance with various embodiments of the disclosure.

FIG. 3B illustrates example outputs of a deep-Q network, in accordance with various embodiments of the disclosure.

FIG. 3C illustrates an example ordering of incentives based on return metric, in accordance with various embodiments of the disclosure.

FIG. 4 illustrates an example algorithm for determining distribution of incentives, in accordance with various embodiments of the disclosure.

FIG. 5 illustrates example results of providing incentives.

FIG. 6 illustrates a flow chart of example an method, in accordance with various embodiments of the disclosure.

FIG. 7 illustrates a block diagram of an example computer system in which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

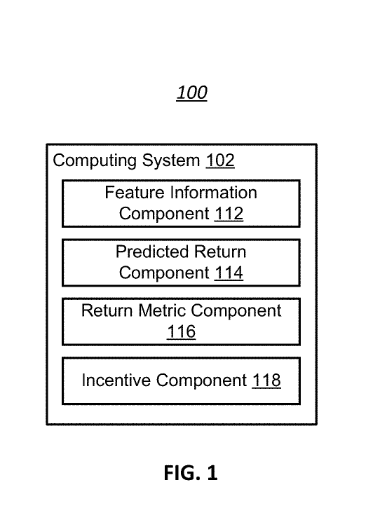

FIG. 1 illustrates an example environment 100 for determining distribution of incentives, in accordance with various embodiments. The example environment 100 may include a computing system 102. The computing system 102 may include one or more processors and memory (e.g., permanent memory, temporary memory). The processor(s) may be configured to perform various operations by interpreting machine-readable instructions stored in the memory. The computing system 102 may include other computing resources and/or have access (e.g., via one or more connections/networks) to other computing resources.

The computing system 102 may include a feature information component 112, a predicted return component 114, a return metric component 116, an incentive component 118, and/or other components. While the computing system 102 is shown in FIG. 1 as a single entity, this is merely for ease of reference and is not meant to be limiting. One or more components/functionalities of the computing system 102 described herein may be implemented in a single computing device or multiple computing devices.

An incentive may refer to a thing that motivates or encourages one or more entities to take certain action(s). An incentive may include a tangible object and/or an intangible object. For example, an incentive may include a physical and/or a digital coupon. An entity may refer to a person or a group of persons. For example, a physical/digital coupon may be provided to an individual or a group of individuals (e.g., a family, a group of customers) to motivate or encourage the individual/group of individuals to take certain actions. For example, coupons may be provided to drivers of vehicles to motivate the drivers to drive the vehicles. Coupons may be provided to passengers of vehicles to motivate the passengers to use the vehicles for rides. Other forms of incentives are contemplated.

While the disclosure is described herein with respect to provision of coupons to drivers and passengers of vehicles, this is merely for illustrative purposes and is not meant to be limiting. The techniques described herein may apply to provision of other incentives to other entities.

Same and/or different types of incentives may be provided to different types of entities. For example, the types of coupons provided to drivers of vehicles to motivate them to drive their vehicles for passengers (e.g., give rides in a ride service) may be same or different from the types of coupons provided to passengers of vehicle to motivate them to use certain types of ride services. For example, incentives for drivers of vehicles may take form of gas coupon (e.g., receive a discount of a certain amount/percentage off the purchase of gas for giving so many rides in a time period/giving rides during a certain time period), a reward coupon (e.g., receive certain reward after giving so many rides), other driver-specific coupons, and/or other coupons. Incentives for passengers of vehicles may take form of discount coupon (e.g., receive a discount of a certain amount/percentage off the total cost of a ride after taking so many riders/during a certain time period), a reward coupon (e.g., receive certain reward after taking so many rides), other passenger-specific coupons, and/or other coupons.

Different incentives may be associated with different costs. For example, providing a particular incentive to a passenger of a vehicle may be associated with a particular cost, such as a cost of a coupon. The cost associated with an incentive may be the same or different from the benefit provided by the incentive to the receiver. For example, providing a discount coupon to a passenger of a vehicle may cost the same or different from the amount of discount provided by the coupon. The cost associated with an incentive may include fixed cost (e.g., specific amount discount cost, such as for a fix amount coupon), variable cost (e.g., variable amount discount cost, such as for a percentage off coupon), and/or other cost.

In some embodiments, a single type of entity may be further subdivided for provision of different incentives. For example, a new/potential driver of a ride service may be provided with different types of coupons than an existing driver of the ride service. As another example, a new/potential passenger of a ride service may be provided with different types of coupons than an existing passenger of the ride service. In some embodiments, incentives may be time-limited. For example, an offer of a coupon may be available for a week after provision.

The feature information component 112 may be configured to obtain feature information for entities. For example, the feature information component 112 may obtain feature information for one or more drivers of vehicles and/or one or more passengers of vehicles. Obtaining feature information may include one or more of accessing, acquiring, analyzing, determining, examining, loading, locating, opening, receiving, retrieving, reviewing, storing, and/or otherwise obtaining the feature information. The feature information component 112 may obtain feature information from one or more locations. For example, the feature information component 112 may obtain script information from a storage location, such as an electronic storage of the computing system 102, an electronic storage of a device accessible via a network, another computing device/system (e.g., desktop, laptop, smartphone, tablet, mobile device), and/or other locations.

Feature information may characterize features of individual entities. Features of individual entities may be defined within feature information and/or determine the values (e.g., numerical values, characters) included within feature information. Features of entities may refer to attributes, characteristic, aspects, and/or other features of entities. Features of entities may include permanent/unchanging features and/or non-permanent/changing features. Feature information may characterize same and/or different features for different types of entities. For example, feature information for drivers of vehicle may characterize driver-specific features, general features, and/or other features of individual drivers/groups of drivers. Feature information for passengers may characterize passenger-specific features, general features, and/or other features of individual passengers/groups of passengers. In some embodiments, features of entities may include one or more predicted features. Predicted features may include features which are predicted based on other information (e.g., other features). For example, based on particular information about passengers, a predicted feature may include whether the passenger is a business person or a homemaker. Other types of predicted features are contemplated.

For example, features of passengers/drivers may include statistical and data mining features, real-time features (e.g., time, weather, location), geographic information features (e.g., traffic conditions, demand conditions, supply conditions), gender information, location of operation information (e.g., particular city in which driver operates), home/base information, vehicle usage information (e.g., type of car used, distance traveled in a given period of time, particular/number of locations traveled), application usage information (e.g., number of log-ins to a rider service app in the past week/month, number of orders for/completion of rides vs number of log-ins), coupon usage information (e.g., number of coupons provided, number of coupons used, values of coupons used, the time window between provision of coupons vs usage of coupons). Other types of features are contemplated.

In some embodiments, feature information may be updated based on reception of new information. For example, feature information for passengers/drivers may be updated based on reception of new/updated information about the passengers/drivers. In some embodiments, feature information may be updated at a periodic interval. For example, feature information for passengers/drivers may be updated at a regular interval (e.g., every day, every week) to provide updated feature information for periodic determination of coupon distribution. For example, it may be desirable to determine coupon distribution on a daily basis. The feature information for the start of a given day may be updated with feature information at the end of the prior day to determine coupon distribution for the given day. That is, the feature information at the end of the prior day may be obtained to determine the coupon distribution for the given day. In some embodiments, feature information may be updated based on demand. For example, the latest feature information may be obtained when coupon distribution is about to be determined. Other updating of feature information are contemplated.

The predicted return component 114 may be configured to determine predicted returns from providing individual incentives associated with different costs to the individual entities based on the feature information and/or other information. A predicted return may refer to what is predicted to be obtained from providing a particular incentive to a particular entity. For example, the predicted return component 114 may make predictions on how much revenue may be made from providing a particular incentive to a particular entity. Predicted returns may be calculated in terms of currency amount and/or other terms. For example, predicted returns may be calculated in terms of gross merchandise volume (GMV) and/or other terms.

In some embodiments, the predicted returns may be determined based on a deep-Q network. A deep-Q network may use a reinforcement learning technique to determine an action-selection policy for a particular process. The inputs to the deep-Q network may include state features for individual drivers/passengers. For example, to determine coupon distribution on a daily basis, states of drivers/passengers may be inputted into the deep-Q network. Different deep-Q networks may be trained for different entities, different location, different times, and/or other characteristics. For example, the predicted return component 114 may input feature information of passengers into a deep-Q network trained for passengers and may input feature information of drivers into a deep-Q network trained for drivers. As another example, the predicted return component 114 may input feature information of drivers into a deep-Q network trained for a particular city/particular part of a city. Other types of deep-Q networks are contemplated.

A deep-Q network may include a Q function, which may determine an expected utility of taken a given action a in a given state s. The Q-function may be used to estimate a potential reward based on inputted state s. That is, the Q-function Q(s, a) may calculate an expected future value based on state s and action a. For example, S may be a set of states S={S₁, S₂, . . . , S_{D}.} where S_{d} denotes the dth driver's state and d ∈ (0, D). S_{d} ∈ R^{T×N} where T is the time collection of driver record by day (such as 2017/05/01) and N is the feature dimension of each record. A may be a set of actions A={A₁, A₂, . . . , A_{D}]. where A_{d} denotes the action to be performed with respect to the dth driver's and d ∈ (0, D). A_{d} ∈ R^{T} where T is the time collection of action record by date (such as 2017/05/01). A_{d,t} may be scalar and may denote the action for the dth driver on the tth date. For instance, the action space may be the costs/amount of the coupons (e.g., 0, 5, 10, 20, 30, 50). A 0 value for the action may correspond to not sending any coupon to the driver.

R may be a set of rewards R={R₁, R₂, . . . , R_{D}. } where R_{d} denotes the reward obtained by the dth driver's and d ∈ (0, D). R_{d} ∈ R^{T} where T is the time collection of action record by date (such as 2017/05/01). R_{d,t} may be scalar and may denote the obtained reward for the dth driver on the tth date. The definition of R_{d,t} may be GMV−ratio*Cost. GMV may be a money amount the dth driver contributed to a given platform on tth date. Cost may be the cost/amount of the coupon. Ratio may reflect the likelihood that the driver will use the coupon.

The outputs of a deep-Q network may be associated with the Q-values of different incentives. For example, outputs of a deep-Q network may be associated with Q-values for providing no coupon (zero cost) to an entity, providing a coupon of a particular cost to the entity, providing a coupon of a different cost to the entity, and so forth. The Q function may provide/may be used to provide the predicted returns from providing incentives associated with different costs to the entities.

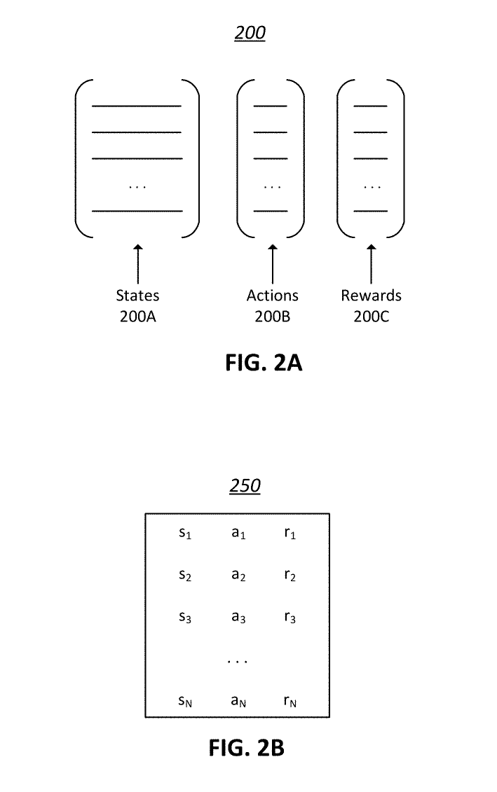

The deep-Q network may be trained using historical information for the entities, where the historical information characterizes activities of the entities for a period of time. For instance, the deep-Q network may be trained using the historical information for the entities based on: storage of at least a portion of the historical information in a replay memory; sampling of a dataset of the information stored in the replay memory; and training of the deep-Q network using the sampled dataset. For example, FIG. 2A illustrates an example historical information 200 for entities (e.g., passengers, drivers). The historical information 200 may include three elements collected for a period of time (e.g., a month): states 200A, actions 200B, and rewards 200C. FIG. 2B illustrates another example historical information 250 for entities. The historical information 250 may include states s, actions a, and rewards r for a period of time. Some or all of the historical information 200, 250 may be stored in a replay memory. A portion of the stored information may be sampled to train the deep-Q network. In some embodiments, a double Deep-Q Network technique may be applied to improve performance of the deep-Q network. The double Deep-Q Network technique may help in avoiding the influence of overestimates from the original Q-target. The estimation may be written as:

$${Y}_{t}^{DoubleQ} ≡ {R}_{t + 1} + γ Q ( {S}_{t + 1} , {arg max}_{a} Q ( {S}_{t + 1} , a ; {θ}_{t} ) ; {θ}_{t}^{′} ) .$$

The replay memory may be configured to store the latest information. That is, as new information is stored in the replay memory, old information may be removed from the replay memory. The replay memory may be used to store transition information for the entities. Transition information may characterize activities of the entities after one or more sets of incentives have been provided to some or all of the entities. For example, transition information may characterize how the drivers/passengers acted in response to receiving coupons. As transition information is stored in the replay memory, the maximum storage capacity of the replay memory (e.g., 10,000 records) may be reached and the oldest information (e.g., historical information) may be removed from/pushed out of the replay memory to make space for the new information (e.g., transition information). A portion of the stored information (e.g., including historical information and/or transition information) may be sampled to update the deep-Q network. In some embodiment, the replay memory may be split up based on individual entities (e.g., based on driver/passenger identifier).

In some embodiments, updating of the deep-Q network may include a change in a last layer of the deep-Q network. The last layer may represent available incentive actions a. That is, rather than changing the entire deep-Q network, the deep-Q network may be updated via changes in a single layer of the deep-Q network.

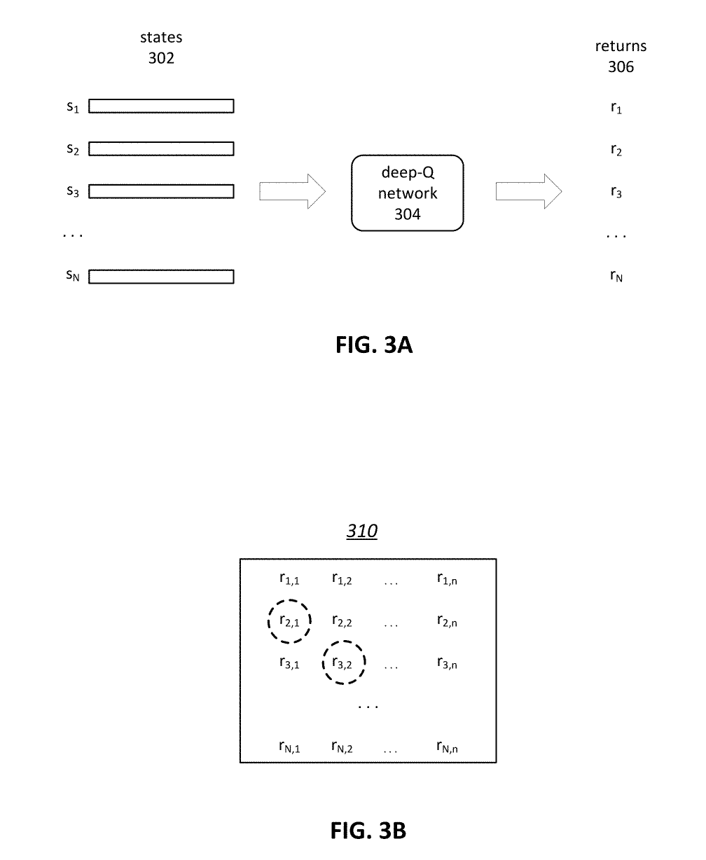

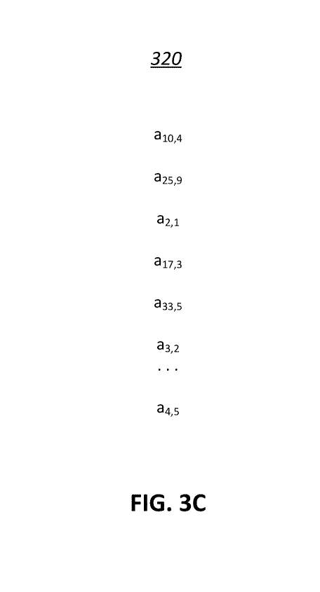

FIG. 3A illustrates example inputs and outputs of a deep-Q network 304. The inputs to the deep-Q network 304 may include states 302 of entities (e.g., passengers, drivers). For example, the states 302 may include states of N entities (s₁, s₂, s₃, . . . , s_{N}). The outputs of the deep-Q network 304 may include returns 306 predicted from providing different incentives to the entities (e.g., N entities). For example, the returns 306 may include returns (r₁, r₂, r₃, . . . , r_{N}) predicted for providing different incentives to N entities based on the states 302 and the training of the deep-Q network 304.

FIG. 3B illustrates example outputs 310 of a deep-Q network. For example, the outputs 310 may correspond to the returns 306 outputted by the deep-Q network 304. For example, return r₁ of the returns 306 may include return r_{1,1}, return r_{1,2}, and so forth as shown in the outputs 310. Return r_{1,1} may correspond to a predicted return determined for providing a particular incentive (action a₁) to an entity characterized by state s₁. Return r_{1,2} may correspond to a predicted return determined for providing a different incentive (action a₂) to the entity characterized by state s₁. Thus, the inputting of the states of entities into the deep-Q network 304 may enable prediction of different returns for providing different incentives to individual entities. For instance, the deep-Q network 304 may output how much GMV may be expected to be obtained for providing coupons of different amounts to drivers/passengers.

The return metric component 116 may be configured to determine return metric from providing the individual incentives to the individual entities based on the predicted returns, the costs of the individual incentives, and/or other information. A return metric may refer to a measurement by which returns predicted from providing incentives to entities may be measured/ranked. For example, a return metric may include a performance measure that evaluates the efficiency of providing a particular incentive to a particular entity and/or to compare the efficiency of providing a particular incentive to a particular entity, the particular incentive to a different entity, and/or a different incentive to the particular/different entity. For instance, the return metric for providing individual incentives to individual entities may be formulated as:

Δd=(max_{a∈A}Q(s, a)−Q(s, 0))/a

The return metric may enable identification of most efficient incentive to be provided to individual entities. For example, the return metric may be used to identify which of the coupons associated with different cost is predicted to generate highest return on investment for a particular entities. For example, referring to FIG. 3B, return r_{2,1} may have the highest return metric for entity characterized by state s₂, while return r_{3,2} may have the highest return metric for entity characterized by state s₃. For instance, providing the entity characterized by state s₂ (second entity) with a first coupon associated with a particular cost (action a₁) may lead to the highest predicted return on investment for the second entity and providing the entity characterized by state s₃ (third entity) with a second coupon associated with particular cost (action a₂) may lead to the highest predicted return on investment for the third entity.

The incentive component 118 may be configured to identify one or more sets of incentives to be provided to one or more of the entities based on the return metric and/or other information. A set of incentives may include one or more incentives to be provided to one or more entities. The incentive component 118 may identify incentives to be provided based on an ordering of the incentives by the return metric. For example, the incentives may be ranked in an order of highest to lowest return metric. FIG. 3C illustrates an example ordering 320 of incentives based on the return metric. In the ordering 320, providing the fourth incentive/coupon (a_{10,4}) for the entity characterized by state s₁₀ (tenth entity) may have the highest return metric, providing the ninth incentive/coupon (a_{25,9}) for the entity characterized by state s₂₅ (twenty-fifth entity) may have the second highest return metric, and so forth. Providing the fifth incentive/coupon (a_{4,5}) for the entity characterized by state s₄ (fourth entity) may have the lowest return metric in the ordering 320. Providing the incentives in order of highest to lowest return metric may ensure that incentives with higher return metric are provided before incentives with lower return metric.

In some embodiments, incentive component 118 may be configured to identify one or more sets of incentives to be provided to one or more of the entities further based on a budget for a period of time. A budget may refer to an amount of expenditure available for providing incentives. A budget may be fixed for a period of time (e.g., a day, a week, two months). The incentive component 118 may identify the set(s) of incentives to the provided by identifying incentives with highest return metric for the individual entities, and selecting the incentives with the highest return metric in an order of highest to lowest return metric until a sum of the costs of the selected incentives reaches the budget. For example, referring to FIG. 3C, the incentive component 118 may select as a set of incentives to be provided to entities the first five incentives (a_{10,4}; a_{25,9}; a_{2,1}; a_{17,3}; a_{33,5}) in the ordering 320 before reaching the budget. That is, the incentive component 118 may select the fourth incentive/coupon to be provided to the tenth entity, the ninth incentive/coupon to be provided to the twenty-fifth entity, the first incentive/coupon to be provided to the second entity, the third incentive/coupon to be provided to the seventeenth entity, and the fifth incentive/coupon to be provided to the thirty-third entity before reaching the budget. The sum of the cost of providing first five incentives in the ordering 320 may result in reaching the budget for providing incentives for a period of time (e.g., spending all of the budget, spending enough of the budget that additional incentives cannot be provided).

The identified set(s) of incentives may be provided to the respective entities via one or more communication techniques. For example, the incentives may be provided to the entities via text message, email, rider service app on a mobile device, physical mail, and/or other communication techniques. For instance, a potential new passenger may be provided with a text message to join a particular ride-service platform and the text message may contain an incentive/a link to an incentive to motivate the entity to join the platform.

The intelligent incentive distribution determination disclosed herein enables identification of both which entities may be provided with an incentive and which particular incentives may be provided to particular entities, while controlling the provision of incentives based on a budget. For example, a budget for providing incentives to drivers of vehicles may be set per each day with the budget preventing distribution of incentives to all drivers. The intelligent incentive distribution determination disclosed herein may be used to maximize the predicted returns from providing incentives for each day by selecting the entities and the incentives with the highest return metric. The intelligent incentive distribution determination may be repeated on a daily basis for an extended period of time (e.g., month) to maximize the predicted returns from providing incentives for the extended period of time. By using the deep-Q network which is updated based on actions taken by the entities in response to provided incentives, the determination of incentive distribution may increase in efficiency over time and/or change in response to changes in entity actions (e.g., change in driving behavior, change in travel behavior).

One or more embodiments of the disclosure may use specific rules to determine distribution of incentives. For example, specific rules may include one or more of obtaining feature information at particular times/intervals, using a deep-Q network trained with historical information to determine predicted returns based on feature information, updating the deep-Q network using transition information, determining return metrics based on costs of the incentives, constraining the identification of incentives for provision based on one or more budgets, and/or other rules described in the disclosure.

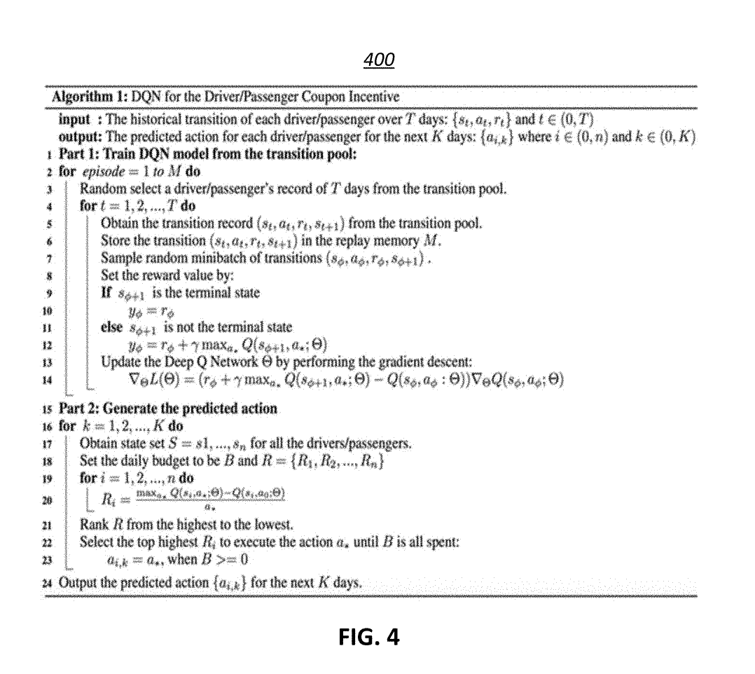

FIG. 4 illustrates an example algorithm 400 for determining distribution of incentives. The algorithm 400 may include a constrained deep-Q network that ranks incentives/entities and uses the ranking to identify which entities will receive which incentives. In the algorithm 400, a deep-Q network may be trained based on historical transition information without building a simulator by pooling the data in a replay memory and randomly sampling mini-batches for training. The last layer of the deep-Q network may be the action set of available incentive actions. For individual entities (e.g., individual drivers/passengers), T days of transition record may be collected in the replay memory and sampled to update the deep-Q network.

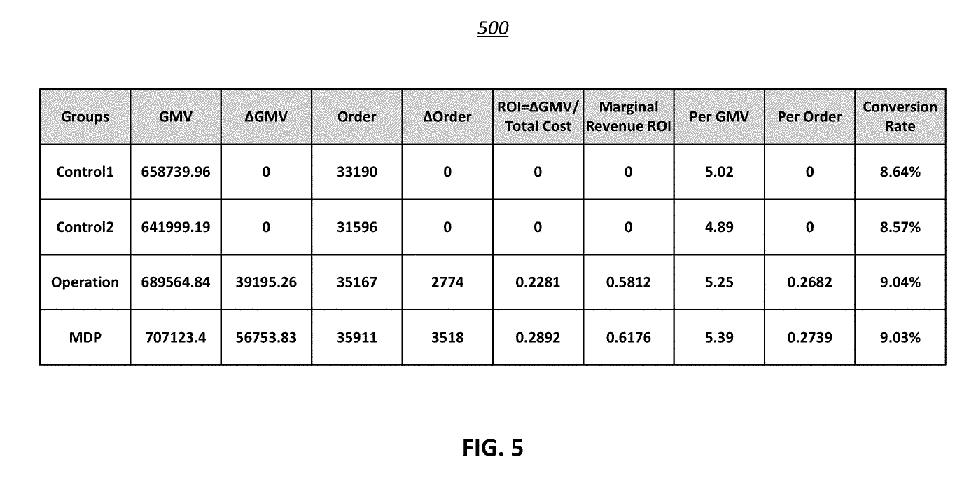

Example results of providing incentives selected based on the intelligent incentive distribution determination are provided in FIG. 5. FIG. 5 illustrates a table 500 showing results of providing different incentives to passengers of vehicles for a month. Passengers in four different cities were provided with incentives, with the passengers partitioned them as four groups: control 1 group, control 2 group, operation group, MDP group. The incentive distribution for the MDP group was determined based on the intelligent incentive distribution determination disclosed herein. The incentive distribution for the operation group was determined based on a baseline method/prediction. No incentives were provided to the control groups. The metrics of the table 500 are provided below:

$$Δ {GMV}_{MDP} = {GMV}_{MDP} - \frac{{GMV}_{Control 1} + {GMV}_{Control 2}}{2}$$

$$Δ {Order}_{MDP} = {Order}_{MDP} - \frac{{Order}_{Control 1} + {Order}_{Control 2}}{2}$$

$${ROI}_{MDP} = \frac{Δ {GMV}_{MDP}}{{Total}_{{Cost}_{MDP}}}$$

$$Marginal Revenue {ROI}_{MDP} = Δ {GMV}_{MDP} / ( {Total\_Cost}_{MDP} - ( {Total\_Cost}_{Control 1} + {Total\_Cost}_{Control 1} ) / 2 )$$

$$Converation {rate}_{MDP} = The number of {Conversation}_{MDP} / {Total\_Passengers}_{MDP}$$

As shown in FIG. 5, the provision of incentives selected based on the intelligent incentive distribution determination resulted in the GMV, ΔGMV, the number of order, ΔOrder, the ROI, and the marginal revenue ROI of the MDP group performing better than that of operation group. Comparing MDP group with the operation group, the GMV increased by 2.54%, the ΔGMV increased by 44.79%, the number of order increased by 2.11%, the ROI is enhanced by 26.75% and Marginal Revenue ROI is increased by 6.27%.

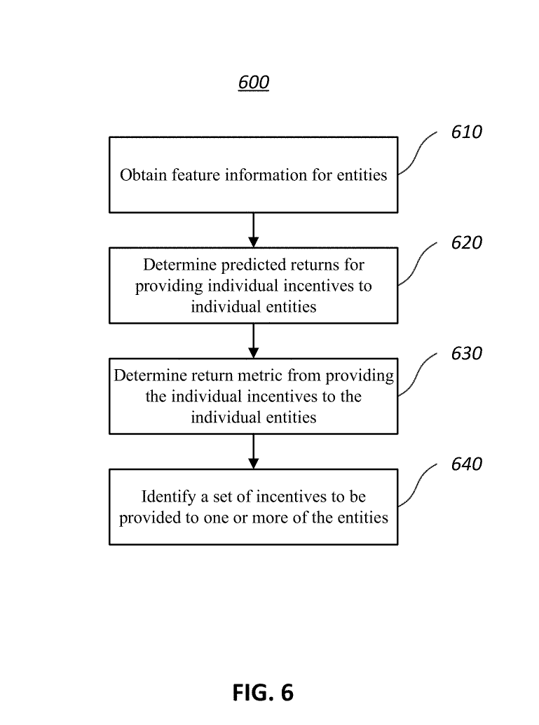

FIG. 6 illustrates a flowchart of an example method 600, according to various embodiments of the present disclosure. The method 600 may be implemented in various environments including, for example, the environment 100 of FIG. 1. The operations of the method 600 presented below are intended to be illustrative. Depending on the implementation, the method 600 may include additional, fewer, or alternative steps performed in various orders or in parallel. The method 600 may be implemented in various computing systems or devices including one or more processors.

With respect to the method 600, at block 610, feature information for entities may be obtained. The feature information may characterize features of individual entities. At block 620, predicted returns from providing individual incentives to the individual entities may be determined based on the feature information. The individual incentives may be associated with different costs. At block 630, return metric from providing the individual incentives to the individual entities may be determined based on the predicted returns and the costs of the individual incentives. At block 640, a set of incentives to be provided to one or more of the entities may be identified based on the return metric.

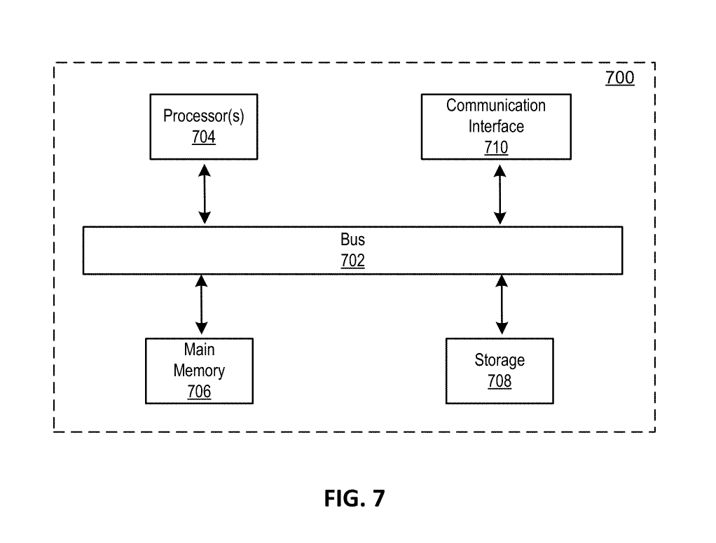

FIG. 7 is a block diagram that illustrates a computer system 700 upon which any of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor(s) 704. Main memory 706 also may be used for storing temporary variables or other intermediate information during execution of instructions to be executed by processor(s) 704. Such instructions, when stored in storage media accessible to processor(s) 704, render computer system 700 into a special-purpose machine that is customized to perform the operations specified in the instructions. Main memory 706 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 708. Execution of the sequences of instructions contained in main memory 706 causes processor(s) 704 to perform the process steps described herein. For example, the process/method shown in FIG. 6 and described in connection with this figure can be implemented by computer program instructions stored in main memory 706. When these instructions are executed by processor(s) 704, they may perform the steps as shown in FIG. 6 and described above. In alternative embodiments, hard-wired circuitry may be used in place of or in combination with software instructions.

The computer system 700 also includes a communication interface 710 coupled to bus 702. Communication interface 710 provides a two-way data communication coupling to one or more network links that are connected to one or more networks. As another example, communication interface 710 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner).

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

What is claimed is:

1. A system for determining incentive distribution, the system comprising:
one or more processors; and
a memory storing instructions that, when executed by the one or more processors, cause the system to perform:
obtaining feature information for entities, the feature information characterizing features of individual entities;
determining predicted returns from providing individual incentives associated with different costs to the individual entities based on the feature information and a deep-Q network;
determining return metric from providing the individual incentives to the individual entities based on the predicted returns and the costs of the individual incentives; and
identifying a set of incentives to be provided to one or more of the entities based on the return metric and a budget for a period of time, wherein identifying the set of incentives includes:
identifying incentives with highest return metric for the individual entities; and
selecting the incentives with the highest return metric in an order of highest to lowest return metric until a sum of the costs of the selected incentives reaches the budget.

2. A system for determining incentive distribution, the system comprising:
one or more processors; and
a memory storing instructions that, when executed by the one or more processors, cause the system to perform:
obtaining feature information for entities, the feature information characterizing features of individual entities;
determining predicted returns from providing individual incentives associated with different costs to the individual entities based on the feature information;
determining return metric from providing the individual incentives to the individual entities based on the predicted returns and the costs of the individual incentives; and
identifying a set of incentives to be provided to one or more of the entities based on the return metric.

3. The system of claim 2, wherein the set of incentives is identified further based on a budget for a period of time.

4. The system of claim 3, wherein identifying the set of incentives includes:
identifying incentives with highest return metric for the individual entities; and
selecting the incentives with the highest return metric in an order of highest to lowest return metric until a sum of the costs of the selected incentives reaches the budget.

5. The system of claim 2, wherein the predicted returns are determined based on a deep-Q network.

6. The system of claim 5, wherein the deep-Q network is trained using historical information for the entities, the historical information characterizing activities of the entities for a period of time.

7. The system of claim 6, wherein the deep-Q network is trained using the historical information for the entities based on:
storage of at least a portion of the historical information in a replay memory;
sampling of a first dataset of the information stored in the replay memory; and
training of the deep-Q network using the first sampled dataset.

8. The system of claim 7, wherein the deep-Q network is updated using transition information for the entities, the transition information characterizing activities of the entities after the set of incentives have been provided to the one or more of the entities.

9. The system of claim 8, wherein the deep-Q network is updated using the transition information for the entities based on:
storage of at least a portion of the transition information in the replay memory, the storage of the at least the portion of the transition information in the replay memory causing at least some of the historical information stored in the replay memory to be removed from the replay memory;
sampling of a second dataset of the information stored in the replay memory; and
updating of the deep-Q network using the second sampled dataset.

10. The system of claim 9, wherein updating of the deep-Q network includes a change in a last layer of the deep-Q network, the last layer representing available incentive actions.

11. The system of claim 2, wherein the entities include at least one passenger of a vehicle or one driver of the vehicle.

12. A method for determining incentive distribution, the method implemented by a computing system including one or more processors and non-transitory storage media storing machine-readable instructions, the method comprising:
obtaining feature information for entities, the feature information characterizing features of individual entities;
determining predicted returns from providing individual incentives associated with different costs to the individual entities based on the feature information;
determining return metric from providing the individual incentives to the individual entities based on the predicted returns and the costs of the individual incentives; and
identifying a set of incentives to be provided to one or more of the entities based on the return metric.

13. The method of claim 12, wherein the set of incentives is identified further based on a budget for a period of time.

14. The method of claim 13, wherein identifying the set of incentives includes:
identifying incentives with highest return metric for the individual entities; and
selecting the incentives with the highest return metric in an order of highest to lowest return metric until a sum of the costs of the selected incentives reaches the budget.

15. The method of claim 12, wherein the predicted returns are determined based on a deep-Q network.

16. The method of claim 15, wherein the deep-Q network is trained using historical information for the entities, the historical information characterizing activities of the entities for a period of time.

17. The method of claim 16, wherein the deep-Q network is trained using the historical information for the entities based on:
storage of at least a portion of the historical information in a replay memory;
sampling of a first dataset of the information stored in the replay memory; and
training of the deep-Q network using the first sampled dataset.

18. The method of claim 17, wherein the deep-Q network is updated using transition information for the entities, the transition information characterizing activities of the entities after the set of incentives have been provided to the one or more of the entities.

19. The method of claim 18, wherein the deep-Q network is updated using the transition information for the entities based on:
storage of at least a portion of the transition information in the replay memory, the storage of the at least the portion of the transition information in the replay memory causing at least some of the historical information stored in the replay memory to be removed from the replay memory;
sampling of a second dataset of the information stored in the replay memory; and
updating of the deep-Q network using the second sampled dataset.

20. The method of claim 19, wherein updating the deep-Q network includes a change in a last layer of the deep-Q network, the last layer representing available incentive actions.
